(19) United States
(12) Patent Application Publication
(10) Pub. No.: US 2017/0146727 A1
(43) Pub. Date: May 25, 2017

(54) DISPLAY DEVICE AND TELEVISION RECEIVER DEVICE

(71) Applicant: Sharp Kabushiki Kaisha, Sakai City, Osaka (JP)

(72) Inventors: Hitoshi KUROYANAGI, Sakai City (JP); Mitsuru TAKESHIMA, Sakai City (JP); Takashi KUMASHIRO, Sakai City (JP)

(21) Appl. No.: 15/316,389

(22) PCT Filed: May 29, 2015
(86) PCT No.: PCT/JP2015/065641

§ 371 Date: Dec. 5, 2016

(30) Foreign Application Priority Data
Jun. 6, 2014 (JP) 2014-117935

(51) Int. Cl. F21V 8/00; H04N 5/64

(52) U.S. Cl. CPC G02B 6/0088; H04N 5/64; G02B 6/0091

(57) ABSTRACT

A display device, or the like, in which heat generated from LED is radiated, and it is possible to provide a plurality of portions to which a stand can be attached is provided.

In the display device, a display unit that displays an image; a light guide plate which is disposed such that one wide face thereof faces the display unit; a substrate on which a light emitting element is mounted; a radiating body which is formed in a plate shape parallel to one side face of the light guide plate, includes a holding unit that holds the substrate such that a mounting face of the light emitting element faces the one side face, and a rear face portion which is connected to the holding unit and is formed in a plate shape parallel to the other wide face of the light guide plate, and is long in a direction along the one side face; and a holder which is formed in a box shape, includes a bonding unit that bonds the radiating body, and holds the light guide plate, in which the bonding unit of the holder is parallel to the other wide face of the light guide plate, a part of the rear face portion of the radiating body is tightly bonded to the bonding unit of the holder, and a fixing portion for attaching a stand for installing to the bonding unit is provided.

### CROSS-REFERENCE TO RELATED APPLICATIONS

This application is the national phase under 35 U. S. C. §371 of PCT International Application No. PCT/JP2015/065641 which has an International filing date of May 29, 2015 and designated the United States of America.

### FIELD

The present invention relates to an edge lit-type display device, and a television receiver device provided with the display device.

### BACKGROUND

A liquid crystal display device provided with a liquid crystal panel as a display panel is thin and lightweight and has low power consumption. Accordingly, in recent years, the liquid crystal display device has been widely used as an image display device for a television receiver device, a computer, and a mobile terminal.

A liquid crystal display device includes a liquid crystal display panel that displays an image on the front surface and a backlight that supplies light to the liquid crystal display panel. There are a directly under type and an edge light type in the backlight. The edge lit-type backlight which has been widely adopted in recent years is configured by placing a reflecting sheet, a light guide plate, and an optical sheet in an overlapping manner on a box-shaped holder having an open side, and disposing a substrate on which a light emitting element such as a light emitting diode (LED) is mounted so as to face one side face of the light guide plate. The liquid crystal display device is configured by further being mounted with the liquid crystal display panel on the backlight so as to face a wide face of the light guide plate, and fixing a frame-shaped front frame to a backlight chassis, by causing the front frame to cover a peripheral edge portion of the liquid crystal display panel. The reflecting sheet, the light guide plate, the optical sheet, and the liquid crystal display panel are fixed in an interposing manner using the front frame and the backlight chassis.

In the liquid crystal display device in which the edge lit-type backlight is adopted, since light of LED is input from one side face of the light guide plate, and is output from the wide face, it may be necessary to have LED with high luminance in order to secure luminance of the liquid crystal display panel. Accordingly, radiating heat generated from LED is an important issue. Regarding such an issue, a display device in which heat is radiated by attaching a substrate on which LED is mounted to a heat spreader which radiates heat and by attaching the heat spreader to a backlight chassis is described in Japanese Patent Publication No. 5335058.

### SUMMARY

However, a heat quantity to be radiated increases along with a progress in high luminance of LED, in association with an increase in size of the liquid crystal display panel, and accordingly, it may be necessary to make the heat spreader large.

Meanwhile, in the liquid crystal display device, a thin type and a slim frame are progressed in order to upgrade an appearance; however, there is a limit here, and a new method is required in order to upgrade the appearance.

One of the methods is a differentiation of a stand that supports the liquid crystal display device so as to mount the device on a mounting face. Accordingly, a configuration in which the stand can be attached in various portions, without being attached only to an attaching position of the stand in the related art may be required.

In the related art, the stand has been fixed to a backlight chassis; however, a plate thickness of the backlight chassis becomes thin in association with a thin and lightweight liquid crystal display device, and it may be necessary to add reinforcements in order to attach the stand. It may be necessary to obtain predetermined rigidity or more, since a weight is put onto a portion to which the stand is attached; however, since the plate thickness of the backlight chassis is thin, reinforcements may be necessary in order to secure rigidity which may be necessary. Accordingly, in a structure in the related art, it may be necessary to increase reinforcing portions in order to attach the stand to various portions of the backlight chassis. However, when increasing reinforcing portions, a weight of the backlight chassis increases, and there is a problem of causing an increase in material cost, and assembling cost.

The disclosure has been made in consideration of such a problem, and an object thereof is to provide a display device in which heat generated from LED is radiated, and it is possible to provide a plurality of portions to which a stand can be attached, without hindering the display device from becoming thin.

A display device according to an aspect of the present disclosure includes a display unit that displays an image on the front side; a light guide plate which is disposed such that one wide face thereof faces the rear side of the display unit; a substrate on which a light emitting element is mounted; a radiating body which is formed in a plate shape parallel to one side face of the light guide plate, includes a holding unit that holds the substrate such that a mounting face of the light emitting element faces the one side face, and a rear face portion which is connected to the holding unit and is formed in a plate shape parallel to the other wide face of the light guide plate, and is long in a direction along the one side face; and a holder which is formed in a box shape having an open side, includes a bonding unit that bonds the radiating body, and holds the light guide plate, in which the light guide plate outputs light which is input to the one side face from the light emitting element from the one wide face, and radiates the light to the display unit, the bonding unit of the holder is parallel to the other wide face of the light guide plate, a part of the rear face portion of the radiating body is tightly bonded to the bonding unit of the holder, and a fixing portion for attaching a stand for installing to the bonding unit is provided.

In the display device according to another aspect of the present disclosure, the fixing portion may be provided in a plurality of portions of the bonding unit.

In the display device according to another aspect of the present disclosure, the radiating body may be screwed to the holder, and a screw insertion hole provided in the radiating body may be a long hole that is long in a longitudinal direction of the radiating body.

In the display device according to another aspect of the present disclosure, a plurality of the long holes may be provided along the longitudinal direction, and an end portion side may be longer than a center side in the longitudinal direction.

A television receiver device according to another aspect of the present disclosure includes the display device described in any one of the above descriptions, and a reception unit that receives television broadcasting, in which an image is displayed on the display device based on the television broadcasting received in the reception unit.

In another aspect of the present disclosure, a radiation amount of heat generated from LED is radiated from LED with high luminance, and it is possible to provide a plurality of portions to which a stand can be attached.

The above and further objects and features will more fully be apparent from the following detailed description with accompanying drawings.

### BRIEF DESCRIPTION OF THE DRAWINGS

FIG. 1 is a perspective view illustrating an appearance of a liquid crystal television;

FIG. 2 is a perspective view illustrating an appearance of the liquid crystal television;

FIG. 3 is an exploded perspective view of portions of the liquid crystal television;

FIG. 4 is a perspective view of a heat spreader;

FIG. 5 is a front view of the heat spreader;

FIG. 6 is a rear view of the heat spreader;

FIG. 7 is a left side view of the heat spreader;

FIG. 8 is a rear perspective view of a backlight chassis;

FIG. 9 is a partial perspective view on the front side of the backlight chassis;

FIG. 10 is a partial perspective view on the rear side of the backlight chassis;

FIG. 11 is a perspective view illustrating an attaching tool that is fixed to the backlight chassis;

FIG. 12 is a perspective view on the rear side of the liquid crystal television and the stand;

FIG. 13 is a partial perspective view of the backlight chassis to which a plurality of the attaching tools are attached; and

FIG. 14 is a front view of the heat spreader.

### DETAILED DESCRIPTION

Hereinafter, the present disclosure will be described in detail based on drawings that illustrate embodiments thereof. Here, a liquid crystal television (hereinafter, described as “liquid crystal TV”) including a display device will be exemplified.

### Embodiment 1

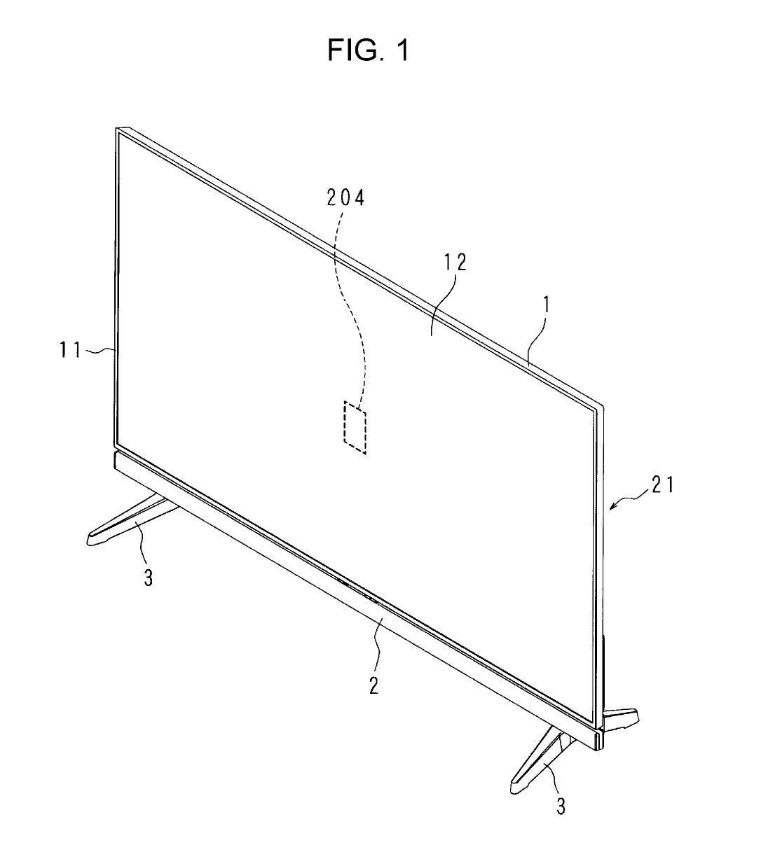

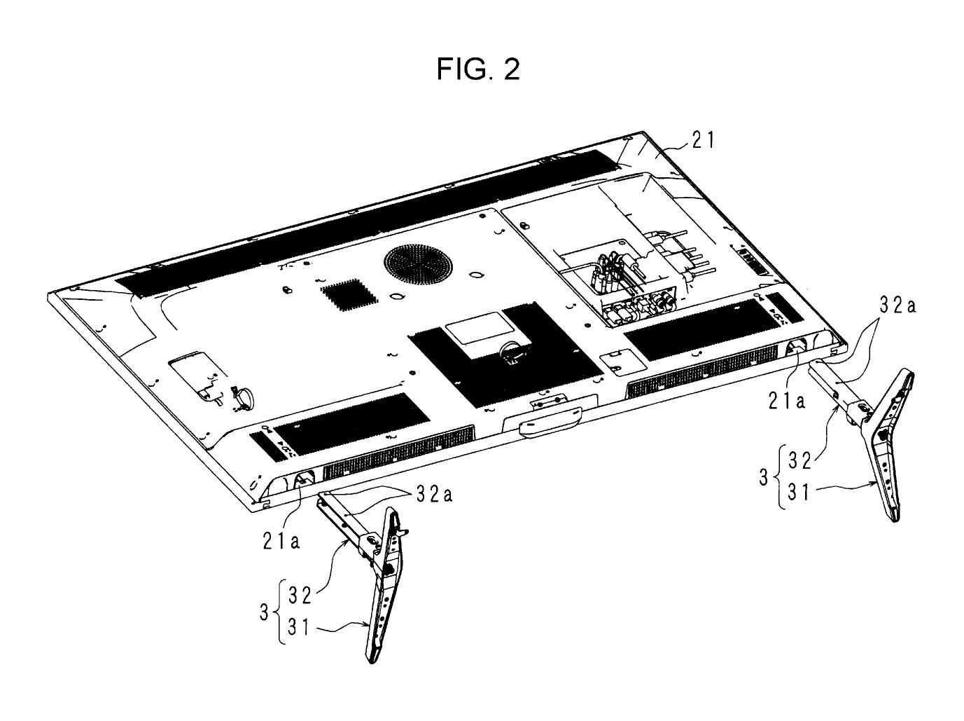

FIGS. 1 and 2 are perspective views illustrating an appearance of a liquid crystal TV 1. The liquid crystal TV 1 includes a front frame 11, a liquid crystal display panel (display unit) 12, a tuner unit 204, a rear cabinet 21, a speaker unit 2, and a stand 3. The front frame 11 is formed in a rectangular frame shape, and covers the peripheral edge of the liquid crystal display panel 12. The rear cabinet 21 is formed in a box shape having an open side. An appearance of the liquid crystal TV 1 is formed when the rear cabinet 21 and the front frame 11 are combined. The liquid crystal display panel 12 is formed in a rectangular plate shape, and displays images. The speaker unit 2 has a dimension in the longitudinal direction which is approximately the same as that of the front frame 11, and is formed in an approximately rectangular parallelepiped shape. The speaker unit 2 is fixed so that one face in the longitudinal direction faces one side face of the front frame 11 in the longitudinal direction. The tuner unit 204 is built in the liquid crystal TV 1. The tuner unit 204 receives television broadcasting, and extracts a broadcasting signal. The broadcasting signal is separated into an image signal and a sound signal using predetermined processing. An image is displayed on the liquid crystal display panel 12 based on the image signal, and sound is output from the speaker unit 2 based on the sound signal. The stand 3 is used so as to mount the liquid crystal TV 1 on a planar face of a table or the like, in an erecting manner.

The stand 3 includes a base portion 31 which is in contact with a mounting face such as a floor, and a column 32 which is fixed to the base portion 31. A screw insertion hole 32a is provided in the column 32. The column 32 is approximately perpendicular to the mounting face in a state in which the base portion 31 is in contact with the mounting face. The rear cabinet 21 is provided with an insertion hole 21a. As will be described later, the column 32 is inserted into the insertion hole 21a in the stand 3. The stand 3 is screwed, using a screw which is inserted into the screw insertion hole 32a from the rear side of the rear cabinet 21.

In the following descriptions, a side on which the liquid crystal display panel 12 of the liquid crystal TV 1 is provided is referred to as a front side, a side opposite to the front side is referred to as a rear side, and left and right sides when facing the liquid crystal display panel 12 are referred to as the left side and the right side, respectively. In addition, upper and lower sides when facing the liquid crystal display panel 12 are referred to as the upper side and the lower side, respectively.

When describing each constituent element of the liquid crystal TV 1, a direction in a state in which each of the constituent elements is assembled will be described.

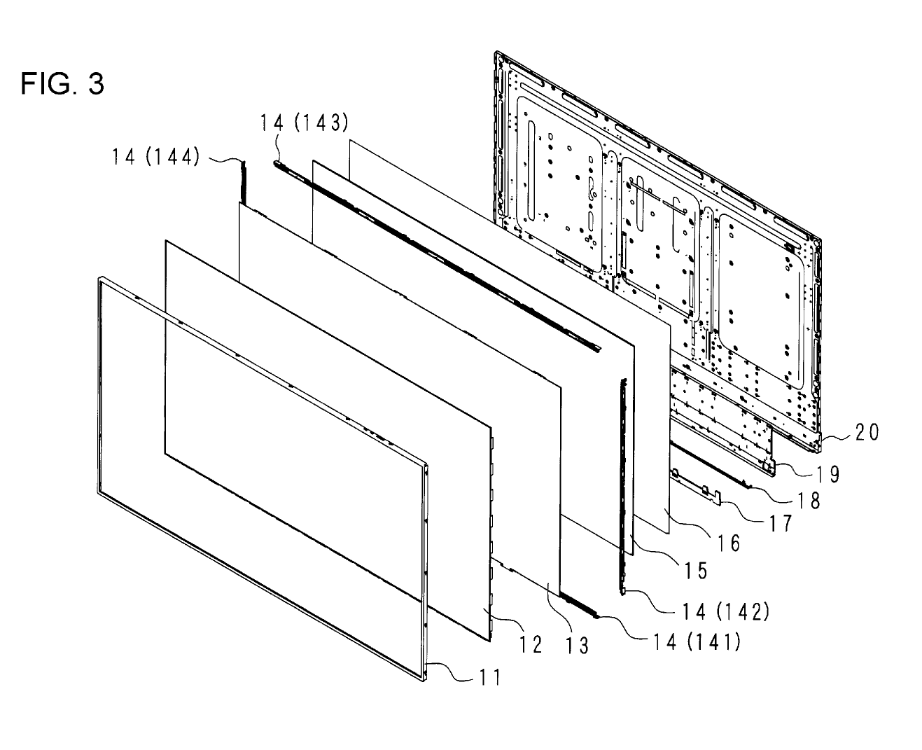

FIG. 3 is an exploded perspective view of portions of the liquid crystal TV 1. The portions of the liquid crystal TV 1 include the front frame 11, the liquid crystal display panel 12, an optical sheet 13, a middle chassis 14, a light guide plate 15, a reflecting sheet 16, a light guide plate holder 17, an LED substrate 18, a heat spreader 19, and a backlight chassis 20.

The optical sheet 13 is a sheet which performs diffusing of light, condensing of light, or the like. The optical sheet 13 is formed by layering plurality of sheets such as a diffusion sheet and a prism sheet.

The middle chassis 14 includes four rod-like members of a lower middle chassis 141, a right middle chassis 142, an upper middle chassis 143, and a left middle chassis 144 which are formed of a resin. Sections of the four middle chassis 141, 142, 143, and 144 are formed in an approximately L shape, respectively. A rectangular frame shape is formed as a whole, when combining the four middle chassis 141, 142, 143, and 144.

The light guide plate 15 is formed of a rectangular acrylic resin with high transparency, for example, and has a predetermined thickness. The light guide plate 15 changes light input from a side face to planar light, and outputs the light from a wide face on one side.

The reflecting sheet 16 is a sheet whose shape in plan view is approximately the same as that of the light guide plate 15. The reflecting sheet 16 totally reflects light input to the front face.

The light guide plate holder 17 is a strip-shaped member which is made of a resin. As will be described later, the light guide plate holder 17 holds the light guide plate 15. In addition, the light guide plate holder is interposed between the reflecting sheet 16 and the heat spreader 19 so that heat transmitted from the heat spreader 19 to the light guide plate 15 and the reflecting sheet 16 is reduced.

The LED substrate (substrate) 18 is formed in a strip shape, and a plurality of white LEDs are mounted from one end to the other end on one face.

The heat spreader 19 is an extrusion molded article using metal with high heat conductivity such as aluminum, for example. A section of the heat spreader 19 is formed in an approximately L shape. The heat spreader 19 has a function of dissipating heat generated in the LED substrate 18.

The backlight chassis 20 is formed in a box shape with a rectangular base having an open side. The backlight chassis 20 is formed by performing press working with respect to a steel sheet. The backlight chassis 20 accommodates the optical sheet 13, the middle chassis 14, the light guide plate 15, the reflecting sheet 16, and the like.

The liquid crystal TV 1 is assembled as follows. A case in which the liquid crystal TV is horizontally constructed will be described. First, the backlight chassis 20 is placed on a workbench, or the like, so that an opening becomes a top. The heat spreader 19 onto which the LED substrate 18 is fixed in advance, using a double-sided tape, is screwed as will be described later. The light guide plate holder 17 is fixed to the heat spreader 19 so as to go along the LED substrate 18. Lower peripheral edge portions of the reflecting sheet 16 and the light guide plate 15 are overlapped so as to be mounted on the heat spreader 19. The lower peripheral edge portions of the reflecting sheet 16 and the light guide plate 15 are held by the light guide plate holder 17, and the left and right peripheral edge portions and the upper peripheral edge portions are held by the backlight chassis 20. In this manner, since the reflecting sheet 16 is not in contact with the heat spreader 19, it is possible to reduce a heat quantity transmitted to the reflecting sheet 16 and the light guide plate 15 from the heat spreader 19. Subsequently, the middle chassis 14 is fixed to the backlight chassis 20 so as to cover the peripheral edge portion on the front side of the light guide plate 15. A side face of the middle chassis 14 fits in the side face of the backlight chassis 20 from the outer side. A protrusion is provided on the side face of the middle chassis 14, and the middle chassis 14 is fixed to the backlight chassis 20 when the protrusion fits into a hole portion which is provided on the side face of the backlight chassis 20.

A peripheral edge portion of the optical sheet 13 is mounted on the middle chassis 14 so as to cover the front face of the light guide plate 15, and the liquid crystal display panel 12 is mounted on the optical sheet 13. The front frame 11 is placed so as to cover the peripheral edge portion of the liquid crystal display panel 12, and the front frame 11 and the backlight chassis 20 are fixed to each other using a screw.

The liquid crystal TV 1 which is configured in this manner displays an image on a display face of the liquid crystal display panel 12 by performing the following operations. White light from the LED substrate 18 is input from one side face of the light guide plate 15. The light guide plate 15 outputs the input light from a wide face. The output light is radiated to the rear side of the liquid crystal display panel 12 through the optical sheet 13. In this manner, an image is displayed on the front side of the liquid crystal display panel 12.

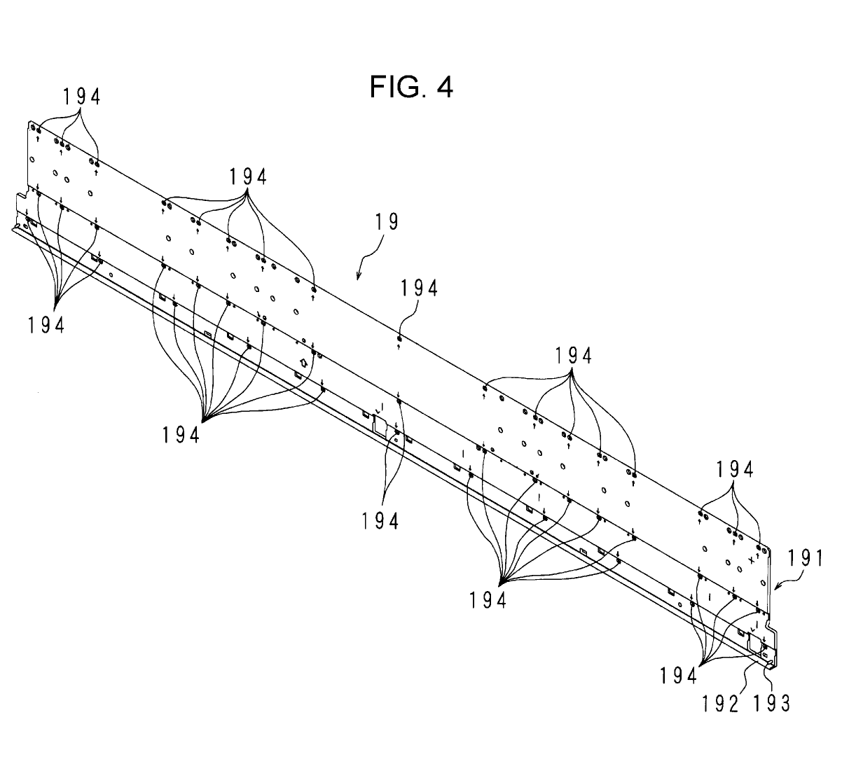

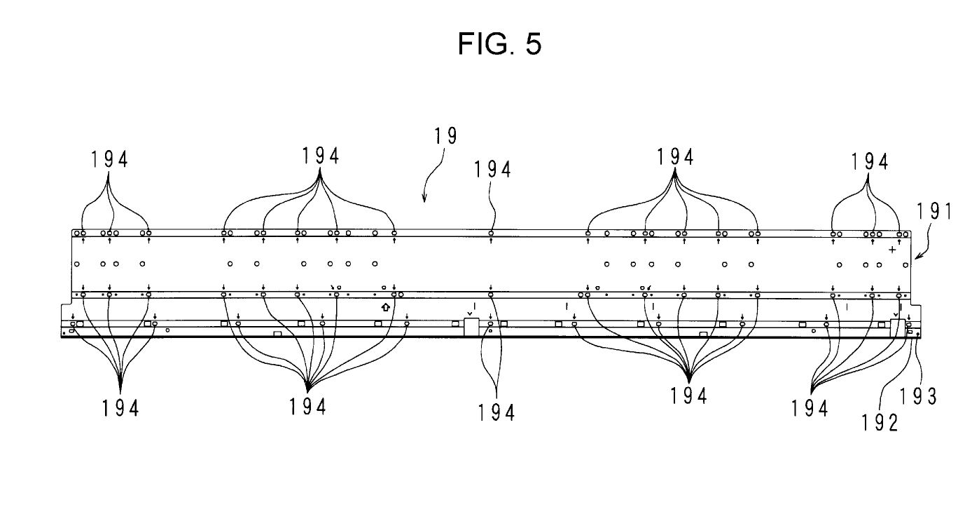

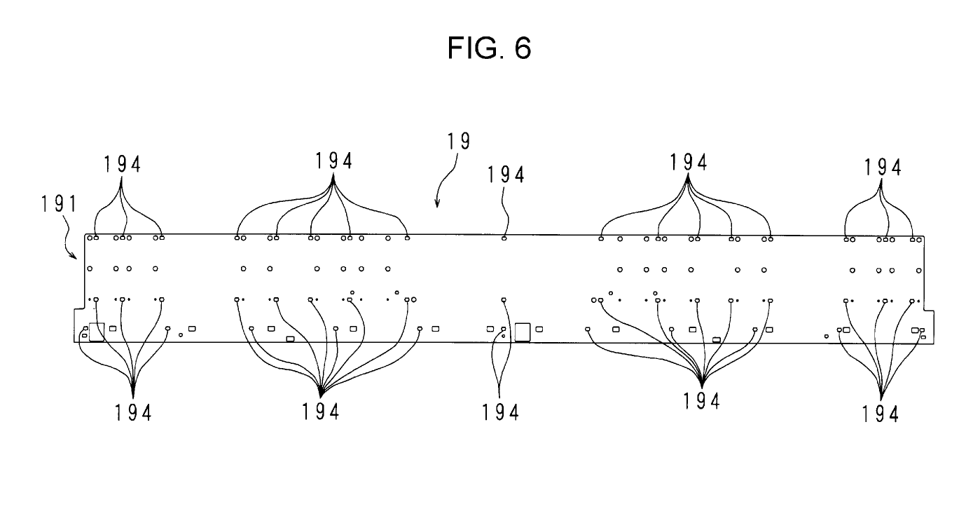

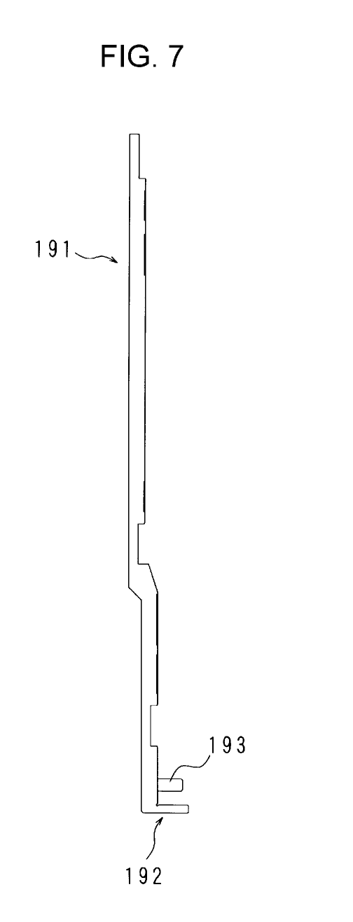

FIG. 4 is a perspective view of the heat spreader 19. FIG. 5 is a front view of the heat spreader 19. FIG. 6 is a rear view of the heat spreader 19. FIG. 7 is a left side view of the heat spreader 19. The heat spreader 19 includes a plate-shaped rear face portion 191 with a wide width, and a substrate fixing portion 192 with a narrow width which is orthogonal to the rear face portion 191, and is formed in an L shape when viewed from a side. As described above, the LED substrate 18 is fixed to the substrate fixing portion 192 using a double-sided tape.

A plurality of screw insertion holes 194 are provided in the rear face portion 191 of the heat spreader 19. The screw insertion holes 194 are aligned along the longitudinal direction of the heat spreader 19. There are seventeen screw insertion holes 194 in total which are aligned in the vicinity of an upper end edge of the heat spreader 19. There are seventeen screw insertion holes 194 in total which are aligned on a slightly lower portion than a center in the vertical direction of the heat spreader 19. There are eleven screw insertion holes 194 in total which are aligned at a position which is slightly separated from a lower end edge portion of the heat spreader 19.

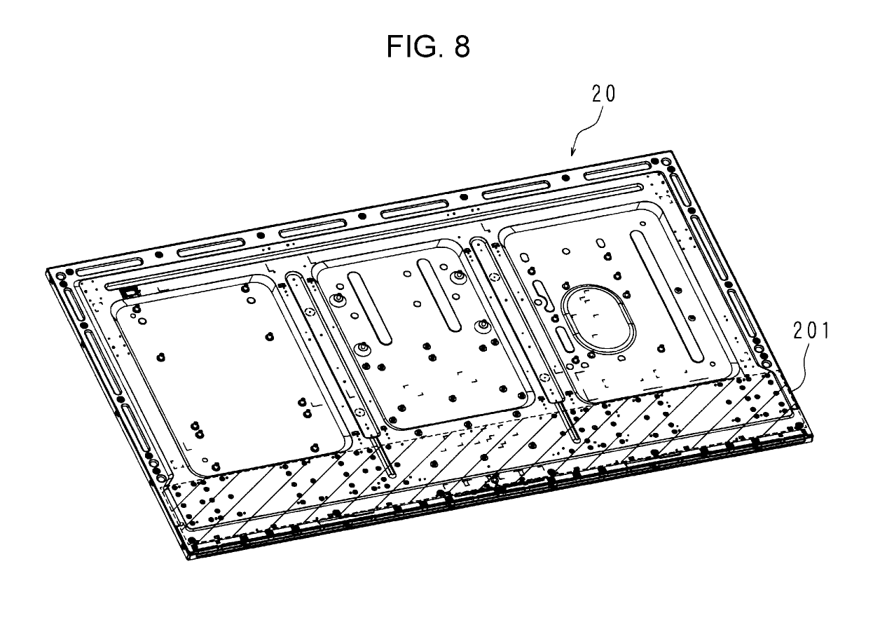

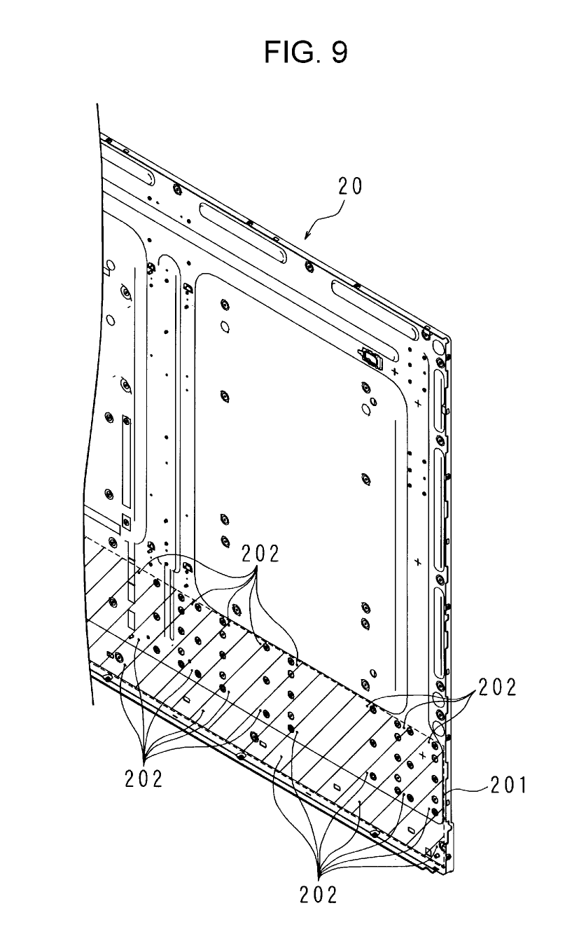

FIG. 8 is a rear perspective view of the backlight chassis 20. A rectangular region with slanted lines, and is surrounded with a dotted line in FIG. 8 is a fixing portion 201 to which the heat spreader 19 is fixed. FIG. 9 is a partial perspective view on the front side of the backlight chassis 20. FIG. 9 illustrates a right end portion. A plurality of screw holes 202 are provided in the fixing portion 201 of the backlight chassis 20. The heat spreader 19 is placed on the fixing portion 201 so that a position of the screw insertion hole 194 of the heat spreader 19 matches a position of the screw hole 202. In addition, when screwing a screw which is inserted into the screw insertion hole 194 to the screw hole 202, the heat spreader 19 is fixed to the fixing portion 201.

As illustrated in FIG. 9, the rear face portion 191 of the heat spreader 19 is fixed, using a plurality of screws so as to be in close contact with the fixing portion 201 of the backlight chassis 20. In this manner, it is possible to efficiently conduct heat to the backlight chassis 20 from the heat spreader 19. In addition, it is possible to increase rigidity of the backlight chassis 20.

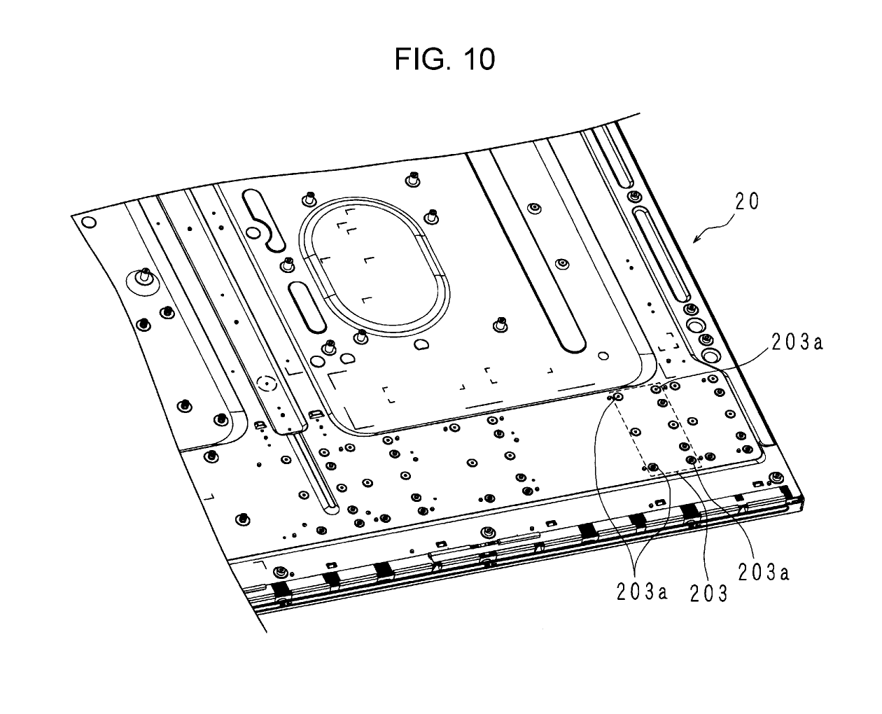

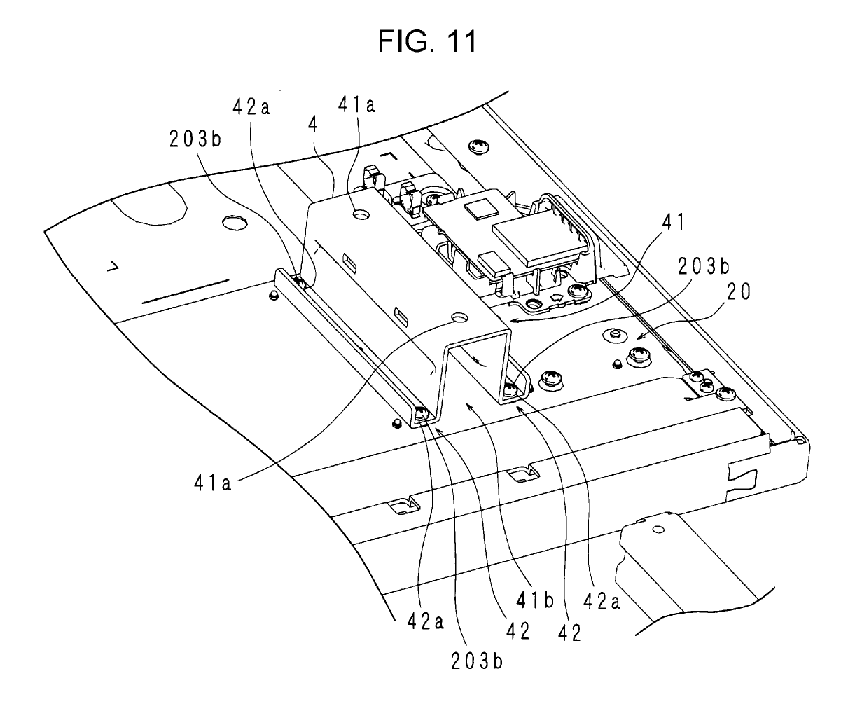

FIG. 10 is a partial perspective view on the rear side of the backlight chassis 20. FIG. 11 is a perspective view illustrating the attaching tool 4 that is fixed to the backlight chassis. FIGS. 10 and 11 illustrate a left corner portion. An attaching portion (fixing portion) 203 for fixing the attaching tool 4 of the stand 3 is provided in the backlight chassis 20. The attaching portion 203 is a rectangular region, and is provided in the fixing portion 201 of the backlight chassis 20. Four screw holes 203a are provided in the attaching portion 203. The four screw holes 203a are disposed so as to be four corners of a rectangle. A cross section of the attaching tool 4 is formed in a U shape, and the attaching tool includes an insertion portion 41 which extends in the vertical direction of the backlight chassis 20, and abutting plate units 42 and 42 which are provided on both edge portions of the insertion portion 41 in the width direction, and formed in a thin and long rectangular shape. Screw insertion holes 41a and 41a are provided at two portions along the longitudinal direction, at a center portion of the insertion portion 41. Screw insertion holes 42a and 42a are provided at two portions along the longitudinal direction, at the abutting plate unit 42. The attaching tool 4 is disposed in the attaching portion 203 so that positions of the screw insertion holes 41a, 41a, 42a, and 42a match the screw holes 203a which are provided in the attaching portion 203, respectively. In addition, the attaching tool 4 is fixed to the attaching portion 203 of the backlight chassis 20 when each screw 203b is inserted into the screw insertion hole 42a, and is screwed to the screw hole 203a. An insertion hole 41b is formed by the backlight chassis 20 and the attaching tool 4.

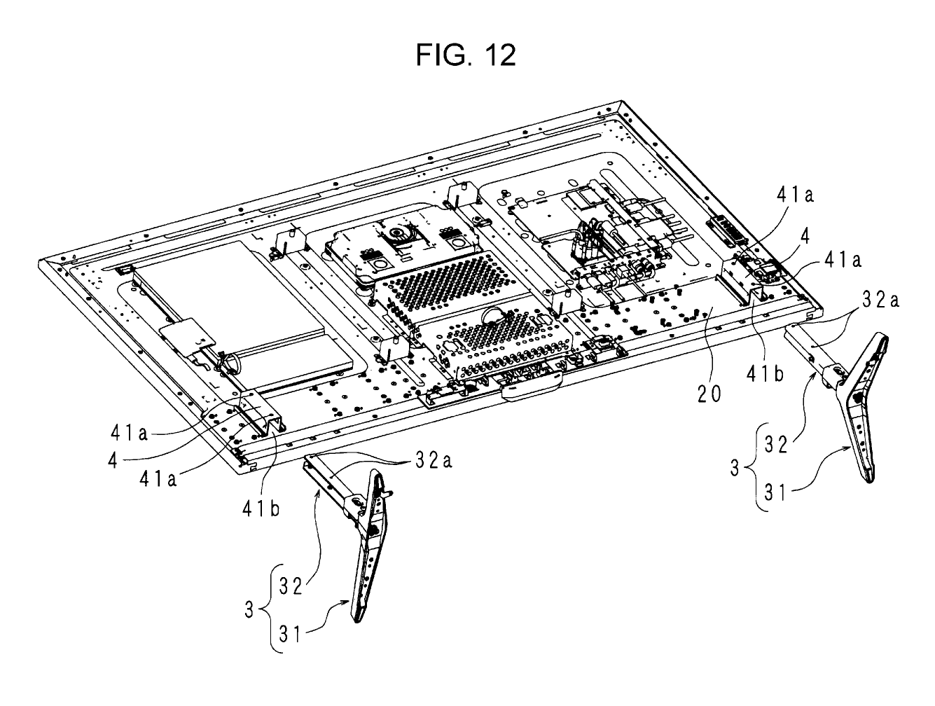

FIG. 12 is a perspective view of the rear side of the liquid crystal TV 1 and the stand 3. The column 32 of the stand 3 is inserted into the insertion hole 41b. The column 32 is fixed to the attaching tool 4 when a screw inserted from the rear side of the rear cabinet 21 is inserted into the screw insertion hole 32a, and is screwed to the screw insertion hole 41a which is provided in the attaching tool 4.

In Embodiment 1, the rear face portion 191 of the heat spreader 19 is fixed so as to be in close contact with the fixing portion 201 of the backlight chassis 20. Accordingly, heat is efficiently conducted to the backlight chassis 20 from the heat spreader 19, and it is possible to radiate the heat in the entire backlight chassis 20. It is possible to efficiently radiate heat which is generated in LED. In this manner, it is possible to suppress a decrease in light emitting efficiency due to a temperature rise of LED. In addition, it is possible to suppress a situation in which cracks occur in a soldered portion, and a contact failure occurs due to a temperature rise of the LED substrate 18. In addition, it is possible to suppress a situation in which a temperature rise in the inside of the liquid crystal TV 1 rises due to heat generated in LED, wrinkles occur in the optical sheet 13 due to thermal expansion, and flare occurs in a display on the liquid crystal display panel 12. In addition, it is possible to inhibit a temperature from being locally increased, by radiating heat generated in LED in the heat spreader 19 and the backlight chassis 20. It is possible to suppress a temperature rise at a portion close to the LED substrate 18 so as to be approximately the same as that in another portion. In this manner, it is possible to suppress a temperature rise at a portion close to the LED substrate 18 in the front frame 11 and the rear cabinet 21 which are portions which a user may touch (touchable portion).

Since the rear face portion 191 of the heat spreader 19 is fixed so as to be in close contact with the fixing portion 201 of the backlight chassis 20, rigidity of the backlight chassis 20 is improved. In this manner, it is possible to fix the attaching tool 4 for attaching the stand 3, without adding a separate member for intensifying the rigidity. Since it may not be necessary to add a separate member, it is possible to inhibit an increase in depth dimension which is caused when attaching the separate member to the backlight chassis 20.

It is preferable that the rear face portion 191 of the heat spreader 19 be in close contact with the entire face of the fixing portion 201 of the backlight chassis 20 without an interval. However, there is a case in which a machining error of the heat spreader 19 and the backlight chassis 20, or an assembling error when fixing the heat spreader 19 to the backlight chassis 20 occurs, and a little interval is caused. In Embodiment 1, it is preferable to set an interval due to such an error to 0.2 mm or less. The reason for this is that, when it is an interval of 0.2 mm, a decrease in heat conductivity due to an air space generated in the interval is not remarkable.

A disposal and the number of screws for fixing the rear face portion 191 of the heat spreader 19 to the fixing portion 201 of the backlight chassis 20 are set so that it is possible to set the above described interval to 0.2 mm or less. Regarding the disposal of the screws, it is preferable to densely dispose the screws in the vicinity of a portion at which the attaching tool 4 is fixed. The reason for this is to secure rigidity of the backlight chassis 20.

### Embodiment 2

In Embodiment 2, a plurality of portions to which the attaching tool 4 for attaching the stand 3 can be fixed are provided. As described above, since the rear face portion 191 of the heat spreader 19 is fixed so as to be in close contact with the fixing portion 201 of the backlight chassis 20, rigidity of the fixing portion 201 of the backlight chassis 20 is improved. Accordingly, it is possible to fix the attaching tool 4 without adding a separate member for securing rigidity in any places, when it is in a range of the fixing portion 201.

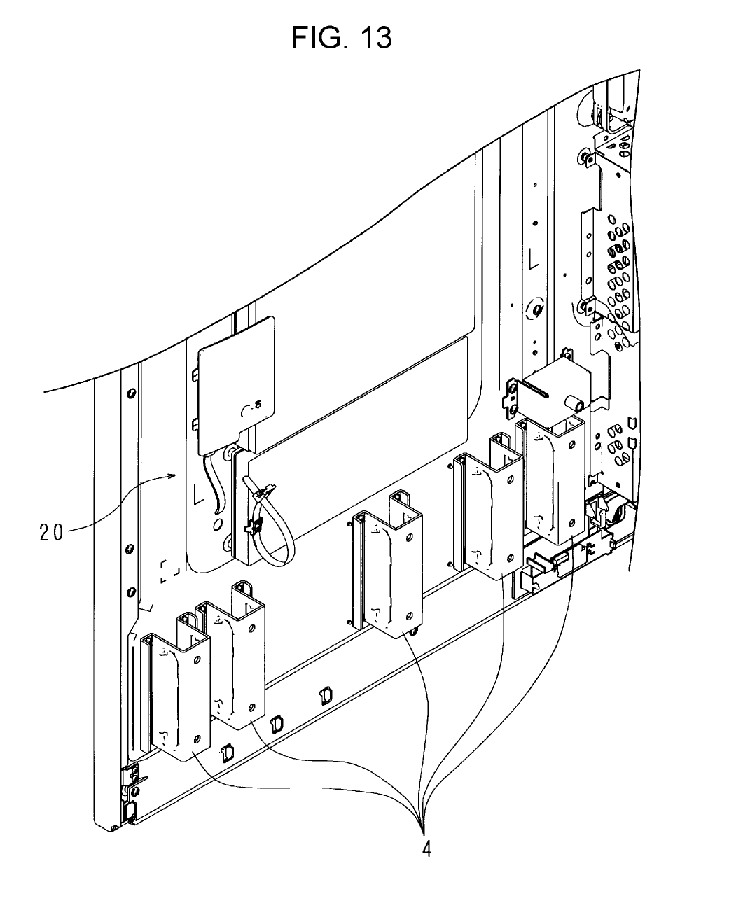

FIG. 13 is a partial perspective view of the backlight chassis 20 to which a plurality of the attaching tools 4 are attached. FIG. 13 illustrates a vicinity of a lower right side on the rear side of the backlight chassis 20. In the example illustrated in FIG. 13, it is possible to fix the attaching tool 4 to five portions. Similarly, it is possible to fix the attaching tool to five portions also on the left side. In FIG. 13, the attaching tool 4 is fixed to all of the five portions for descriptions; however, the attaching tool 4 may be fixed to one portion on the left and right sides, conforming with attaching portions of the stand 3.

As described above, in Embodiment 2, the following effects are exerted, in addition to effects exerted in Embodiment 1. Since the attaching tool 4 of the stand 3 can be fixed to a plurality of portions of the backlight chassis 20, it is possible to allow a degree of freedom to attaching portions of the stand 3. In addition, it allows commonality of the backlight chassis 20 across types in which attaching portions of the stand 3 are different.

### Embodiment 3

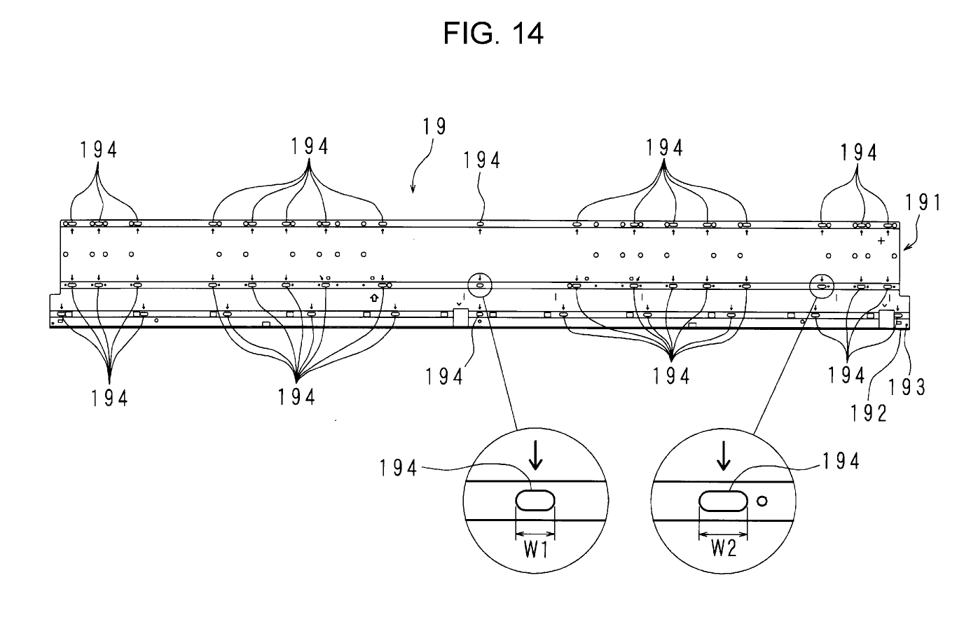

In Embodiment 3, the screw insertion hole 194 which is provided in the heat spreader 19 in order to fix the heat spreader 19 to the backlight chassis 20 is set to a long hole. FIG. 14 is a front view of the heat spreader 19. The screw insertion hole 194 which is provided in the heat spreader 19 is set to be long in the longitudinal direction, that is, a horizontal direction of the liquid crystal TV 1. The reason for setting the screw insertion hole 194 to a long hole is to suppress a defect caused by thermal expansion of members due to a temperature rise in the inside of the liquid crystal TV 1, or thermal contraction due to a temperature fall in the inside thereof.

As described above, the rear face portion 191 of the heat spreader 19 is fixed so as to be in close contact with the fixing portion 201 of the backlight chassis 20. However, it is not preferable to perform fixing in a state in which both thereof lost a degree of freedom, completely. It is preferable to allow a relative shift along a direction along a contact face of both. The reason for this is that the heat spreader 19 and the backlight chassis 20 are formed of different materials. The backlight chassis 20 is formed of a steel plate in order to secure certain fixed rigidity, even if it is thin. The heat spreader 19 is formed of aluminum in order to efficiently radiate heat.

Since the heat spreader 19 and the backlight chassis 20 are formed of different materials, a coefficient of thermal expansion and a coefficient of thermal contraction thereof are different. Accordingly, when not setting a structure in which a relative shift is allowed in the direction along the contact face of both, there is a possibility that distortion may occur in the heat spreader 19 and the backlight chassis 20, or the heat spreader and the backlight chassis may be damaged due to the difference in coefficient of thermal expansion and coefficient of thermal contraction. Therefore, the screw insertion hole 194 which is provided in the heat spreader 19 is set to a long hole.

As described above, when setting a group which is aligned in the longitudinal direction of the heat spreader 19 to one group, it is possible to divide the screw insertion holes 194 into three groups. In Embodiment 3, in each group, a length W2 of a screw insertion hole 194 which is located close to the end portion is set to be longer than a length W1 in the horizontal direction of a screw insertion hole 194 located close to the center. The same is applied to other screw insertion holes 194. Screw insertion holes 194 which are located on the same positions in the horizontal direction, and are located at positions different in the vertical direction may be set to the same length. Screw insertion holes 194 which are located at a center in the horizontal direction may be set to a round hole. The reason for this is to suppress a situation in which a position shift of the heat spreader 19 and the backlight chassis 20 occurs in the center in the horizontal direction. When the position shift occurs in the horizontal direction, a decrease in luminance due to an insufficient input of light from LED to a side face of the light guide plate 15, or uneven luminance due to varying input of light to the side face of the light guide plate 15 occurs. It is possible to suppress such a deterioration in display quality.

As described above, in Embodiment 3, the following effects are exerted, in addition to the effects in Embodiments 1 and 2. The screw insertion hole 194 provided in the heat spreader 19 is set to a long hole which is long in the horizontal direction, and a length on the end portion side in the horizontal direction is set to be longer than that on the center side. In this manner, it is possible to make a deterioration in display quality due to a position shift small in the vicinity of the center which easily attracts a user's attention, by minimizing the position shift of the heat spreader 19 and the backlight chassis 20 due to thermal expansion or thermal contraction in the vicinity of the center in the horizontal direction.

Technical features (constituent elements) which are described in each embodiment can be combined with each other, and it is possible to form new technical features by combining thereof.

The embodiments which are disclosed this time are examples in every aspect, and are considered to be embodiments which are not limited. The scope of the invention is disclosed by the description of the scope of claims, not the above described meaning, and further includes equivalent meanings to the description of the scope of claims, and all of changes in the scope.

As described above, the display device 1 according to an aspect of the present disclosure includes the display unit 12 that displays an image on the front side; the light guide plate 15 which is disposed such that one wide face thereof faces the rear side of the display unit 12; the substrate 18 on which a light emitting element is mounted; the radiating body 19 which is formed in a plate shape parallel to one side face of the light guide plate 15, includes the holding unit 192 that holds the substrate 18 such that a mounting face of the light emitting element faces the one side face, and the rear face portion 191 which is connected to the holding unit 192 and is formed in a plate shape parallel to the other wide face of the light guide plate 15, and is long in a direction along the one side face; and a holder 20 which is formed in a box shape having an open side, includes a bonding unit 201 that bonds the radiating body 19, and holds the light guide plate 15, in which the light guide plate 15 outputs light which is input to the one side face from the light emitting element from the one wide face, and radiates the light to the display unit 12, the bonding unit 201 of the holder 20 is parallel to the other wide face of the light guide plate 15, a part of the rear face portion 191 of the radiating body 19 is tightly bonded to the bonding unit 201 of the holder 20, and the fixing portion 203 for attaching the stand 3 for installing to the bonding unit 201 is provided.

In an aspect of the present disclosure, since the rear face portion of the radiating body is tightly bonded to the bonding unit of the holder, it is possible to radiate heat in the entire radiating body and holder, by causing heat generated in the light emitting element to be efficiently conducted to the holder from the radiating body. In addition, since rigidity of the holder increases when the rear face portion of the radiating body is bonded to the bonding unit of the holder, it is possible to provide the fixing portion for attaching the stand for installing, without attaching a new reinforcing member to the holder.

In the display device 1 according to another aspect of the present disclosure, the fixing portion 203 is provided in a plurality of portions of the bonding unit 201.

In another aspect of the present disclosure, since rigidity of the entire bonding unit of the holder increases, it is possible to provide the fixing portion at a plurality of portions.

In the display device 1 according to another aspect of the present disclosure, the radiating body 19 is screwed to the holder 20, and the screw insertion hole 194 which is provided in the radiating body 19 is set to a long hole that is long in the longitudinal direction of the radiating body 19.

In another aspect of the present disclosure, the screw insertion hole provided in the radiating body is set to a long hole which is long in the longitudinal direction of the radiating body, it is possible to inhibit both of the radiating body and the holder from being deformed or damaged due to thermal expansion or thermal contraction, even when the radiating body and the holder are formed of members of which a coefficient of thermal expansion or a coefficient of thermal contraction is different.

In the display device 1 according to another aspect of the present disclosure, the plurality of long holes are provided along the longitudinal direction, and an end portion side is longer than a center side in the longitudinal direction.

In another aspect of the present disclosure, since the long hole is set to be long on the end portion side compared to the center side in the longitudinal direction, it is possible to reduce a shift from each other in the center position, even when the radiating body and the holder are subjected to the thermal expansion or the thermal contraction. In this manner, it is possible to reduce a shift in the center position of the light guide plate and the substrate, and suppress a deterioration in display quality due to the position shift.

The television receiver device according to another aspect of the present disclosure is provided with a display device which is described in any one of the above descriptions, and a reception unit that receives television broadcasting, and displays an image on the display device based on the television broadcasting received in the reception unit.

In another aspect of the present disclosure, since the rear face portion of the radiating body is tightly bonded to the bonding unit of the holder, it is possible to radiate heat in the entire radiating body and holder, by causing heat generated in the light emitting element to be efficiently conducted to the holder from the radiating body. In addition, since rigidity of the holder increases when the rear face portion of the radiating body is bonded to the bonding unit of the holder, it is possible to provide the fixing portion for attaching the stand for installing, without attaching a new reinforcing member to the holder.

It is to be noted that, as used herein and in the appended claims, the singular forms “a”, “an”, and “the” include plural referents unless the context clearly dictates otherwise.

1-5. (canceled)

6. A display device, comprising:
a display unit that displays an image on the front side;
a light guide plate which is disposed such that one wide face thereof faces the rear side of the display unit;
a substrate on which a light emitting element is mounted;
a radiating body which is formed in a plate shape parallel to one side face of the light guide plate, includes a holding unit that holds the substrate such that a mounting face of the light emitting element faces the one side face, and a rear face portion which is connected to the holding unit and is formed in a plate shape parallel to the other wide face of the light guide plate, and is long in a direction along the one side face; and
a holder which is formed in a box shape having an open side, includes a bonding unit that bonds the radiating body, and holds the light guide plate,
wherein the light guide plate outputs light which is input to the one side face from the light emitting element from the one wide face, and radiates the light to the display unit,
wherein the bonding unit of the holder is parallel to the other wide face of the light guide plate,
wherein a part of the rear face portion of the radiating body is tightly bonded to the bonding unit of the holder, and
wherein a fixing portion for attaching a stand for installing to the bonding unit is provided.

7. The display device according to claim 6,
wherein the fixing portion is provided in a plurality of portions of the bonding unit.

8. The display device according to claim 6,
wherein the radiating body is screwed to the holder, and
wherein a screw insertion hole provided in the radiating body is a long hole that is long in a longitudinal direction of the radiating body.

9. The display device according to claim 8,
wherein a plurality of the long holes are provided along the longitudinal direction, and an end portion side is longer than a center side in the longitudinal direction.

10. A television receiver device comprising:
the display device according to claim 6; and
a reception unit that receives television broadcasting,
wherein an image is displayed on the display device based on the television broadcasting received in the reception unit.
